(19) United States
(12) Patent Application Publication
(10) Pub. No.: US 2016/0169482 A1
(43) Pub. Date: Jun. 16, 2016

(54) HIGH POWER LED LIGHTING DEVICE

(71) Applicant: KMW INC., HWASEONG (KR)

(72) Inventor: DUK-YONG KIM, HWASEONG (KR)

(73) Assignee: KMW INC.

(21) Appl. No.: 15/050,734

(22) Filed: Feb. 23, 2016

Related U.S. Application Data
(63) Continuation of application No. PCT/KR2014/007891, filed on Aug. 25, 2014.

(30) Foreign Application Priority Data
Aug. 23, 2013 (KR) 10-2013-0100468

(51) Int. Cl. F21V 13/04; F21V 29/76

(52) U.S. Cl. CPC F21V 13/04; F21V 29/763; F21W 2131/105

(57) ABSTRACT

Disclosed is a high power LED lighting device. The high power LED lighting device includes: a substrate on which a plurality of LED groups, each of which including a plurality of LEDs in a row direction, is arranged in a column direction and the LED groups have a wider distance therebetween than that between the LEDs belonging to each LED group; a plurality of reflection units which are located between the LED groups on a front surface of the substrate and reflect lights emitted from the LED groups to form light distribution; and a heat radiation unit attached to a rear surface of the substrate to radiate heat. In the high power LED lighting device, the LEDs are arranged to be advantageous for radiating heat so that a distance between the LED devices may be reduced in a transverse direction so as to minimize an area, and a desired distance of the LED devices is maintained in a longitudinal direction. Accordingly, the area of the LED lighting device of relatively large capability can be reduced.

### CROSS REFERENCE TO RELATED APPLICATIONS

This application is a continuation of International Application No. PCT/KR2014/007891 filed on Aug. 25, 2014, which claims priority to Korean Application No. 10-2013-0100468 filed on Aug. 23, 2013, which applications are incorporated herein by reference.

### TECHNICAL FIELD

The present invention relates to a high power LED lighting device, and more particularly to a high power LED lighting device capable of illuminating a wide area such as a playing field.

### BACKGROUND ART

Generally, an outdoor stadium such as a baseball field, a football field, sports complex and the like has a light tower. The light tower with an output of at least 800 watts is required in order to illuminate a playing field during a match, and consumes much electric power.

Recently, technologies using LED lighting have been developed in order to reduce electric power consumption of the lighting for the playing field.

Korean Patent Laid-open Publication No. 10-2010-0009423, entitle “lighting device for playing field using LED lamps”, published on Jan. 27, 2010, discloses the lighting device for a playing field using LED lamps. A technical structure of the above-mentioned Korean Patent Laid-open Publication No. 10-2010-0009423 includes a body having a plurality of insertion holes aligned upward, downward, left and right, LED devices inserted in the insertion holes respectively, a heat radiation plate, and a circulation cooler.

However, in this structure, considering an output of one LED device with 0.2 to 0.5 watts, sixteen hundred to four thousand LED devices have to be mounted in order to provide lighting equal to or more than 800 watts. Even though a high power LED device of 1watt is used in order to reduce the number of necessary LED devices, eight hundred forty LED devices are required.

In the lighting device according to Korean Patent Laid-open Publication No. 10-2010-000943, since an insertion hole corresponding to every LED device must be prepared, there is a problem in that an area of the lighting device significantly increases.

Further, a circulation cooler must be mounted on the lighting device in order to radiate heat discharged from the LED device. Therefore, low power lighting cannot be achieved in consideration of electric power consumed by the circulation cooler. In addition, there is a problem in that a size of the lighting device increases, and a manufacturing cost increases.

### SUMMARY

The present invention has been made to solve the above-mentioned problems in the prior art, and an aspect of the present invention is to provide a high power LED lighting device which has a simple structure and a small size, and provides suitable light distribution as a lighting for a playing field.

In accordance with an aspect of the present invention, a high power LED lighting device is provided. The high power LED lighting device includes: a substrate on which a plurality of LED groups, each of which including a plurality of LEDs in a row direction, is arranged in a column direction and the LED groups have a wider distance therebetween than that between the LEDs belonging to each LED group; a plurality of reflection units which are located between the LED groups on a front surface of the substrate and reflect light emitted from the LED groups to form light distribution; and a heat radiation unit attached to a rear surface of the substrate to radiate heat.

In the LED lighting device of large capability according to the present invention, the LEDs are arranged to be advantageous for radiating heat so that a distance between the LED devices is reduced in a transverse direction so as to minimize an area, and a desired distance of the LED devices is maintained in a longitudinal direction. Accordingly, the area of the high power LED lighting device can be reduced.

Further, in the high power LED lighting device according to the present invention, a reflection plate is used which can achieve light distribution to directly illuminate the playing field far from a mounting position of the LED lighting device. The reflection plate is commonly mounted to an LED group including a plurality of LEDs to prevent an increase of the area of the LED lighting device.

In addition, in the LED lighting device according to the present invention, a lens pattern is used which is formed in a direction perpendicular to the reflection plate, thereby providing the suitable light distribution as the lighting for the playing field.

### BRIEF DESCRIPTION OF DRAWINGS

The above and other aspects, features, and advantages of the present invention will be more apparent from the following detailed description taken in conjunction with the accompanying drawings, in which:

FIG. 1 is a plane view illustrating a high power LED lighting device according to a preferred embodiment of the present invention;

FIG. 2 is a sectional view of the LED lighting device, taken along line A-A′ of FIG. 1;

FIG. 3 is a partially sectional view of the LED lighting device, taken along line B-B′ of FIG. 1;

FIG. 4 is a graph illustrating a result of a simulation which shows a vertical light distribution pattern of the present invention;

FIGS. 5 and 6 are sectional views illustrating a high power LED lighting device according to another embodiment of the present invention;

FIG. 7 is a graph illustrating a result of a simulation which shows a horizontal light distribution pattern of the present invention; and

FIGS. 8 and 9 are sectional views illustrating examples of a protruding optical pattern which is applied to the present invention, respectively.

### DETAILED DESCRIPTION

Hereinafter, a high power LED lighting device of the present invention will be described in detail with reference to the accompanying drawings.

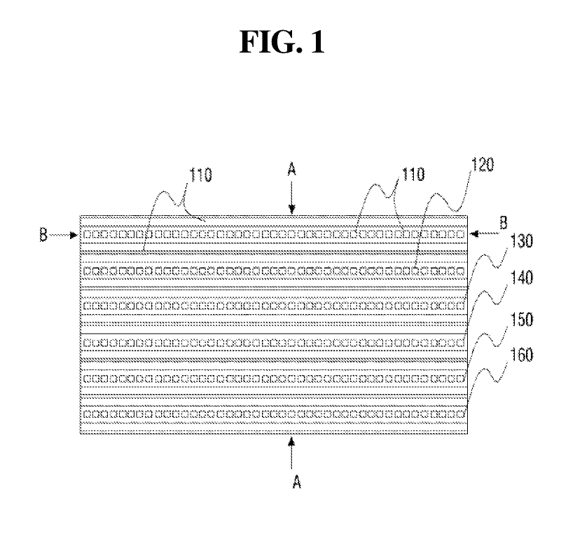

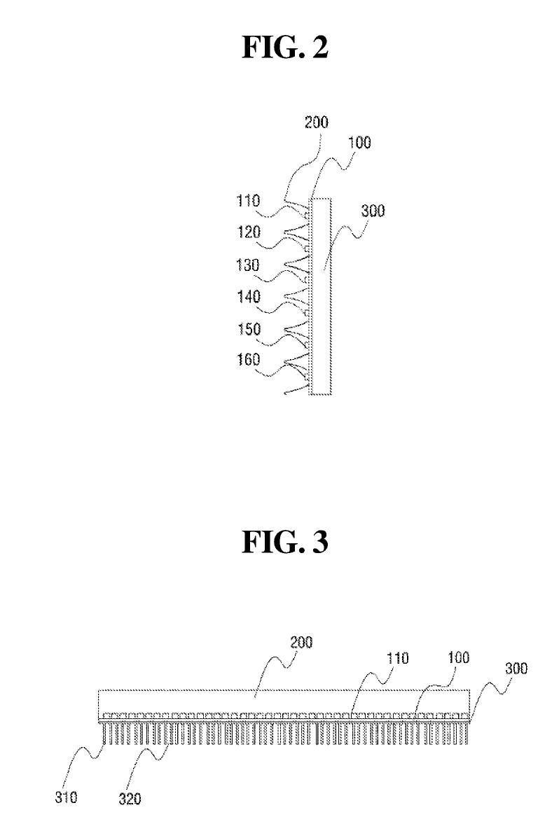

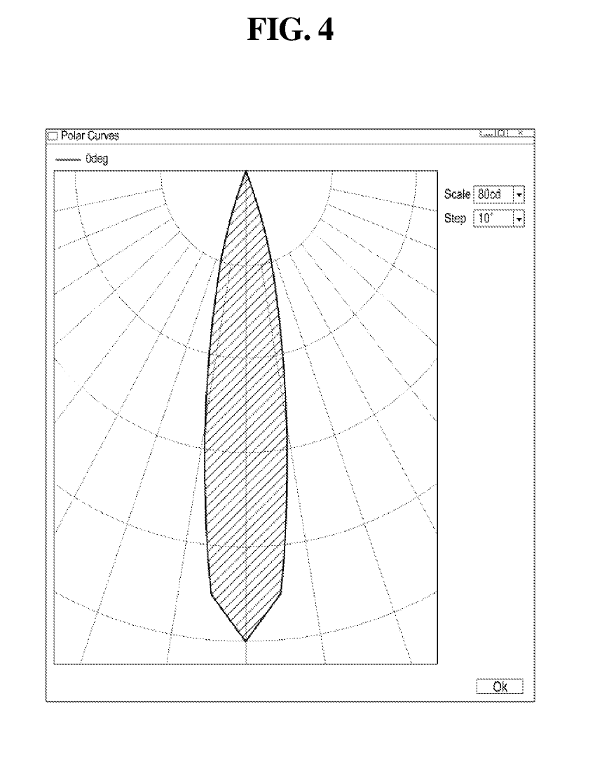

FIG. 1 is a plane view illustrating a high power LED lighting device according to an exemplary embodiment of the present invention, and FIG. 2 is a sectional view illustrating the LED lighting device, taken along line A-A, and FIG. 3 is a partially section view illustrating the LED lighting device, taken along line B-B. Referring to FIGS. 1 to 3, the LED lighting device of a high power according to the exemplary embodiment of the present invention includes a substrate 100, LED devices which are arranged in a plurality of rows and columns and have distances of the rows narrower than those of the columns, and which form first to sixth LED groups 110, 120, 130, 140, 150 and 160 in a column direction, reflection plates 200 located between the LED groups 110, 120, 130, 140, 150 and 160 to form narrow light distribution patterns, and a heat radiation unit 300 attached to a rear surface of the substrate 100 to discharge heat of the first to sixth LED groups 110, 120, 130, 140, 150 and 160.

Hereinafter, the structure and operation of the high power LED lighting device according to the exemplary embodiment of the present invention constructed as described above will be described in detail.

Firstly, a plurality of LEDs is arranged on the substrate 100 in a matrix form, in which the LEDs of a row direction have a narrower distance than that of the LEDs in a column direction. In the column direction, the LEDs are arranged in six rows, which form the first to sixth LED groups 110, 120, 130, 140, 150 and 160.

For example, in the case of using an LED device of 1 watt, about eight hundred forty LEDs must be used, and each of the first to sixth LED groups 110, 120, 130, 140, 150 and 160 is configured of one hundred forty LEDs.

In this event, the first to sixth LED groups 110, 120, 130, 140, 150 and 160 are spaced at a constant distance from one another, so that heat radiation can be rapidly performed. Further, the LEDS belonging to each of the first to sixth LED groups 110, 120, 130, 140, 150 and 160 are arranged at a minimum distance to be allowable in the manufacturing thereof, thereby reducing an entire area.

This prevents a degradation of the heat radiation effect when the plurality of the LEDs is arranged in the limited area.

The reflection plates 200 are provided between the first to sixth LED groups 110, 120, 130, 140, 150 and 160, at an upper portion of the first LED group 110, and at a lower portion of the sixth LED group 160. The reflection plates 200, which are arranged at the upper portion and the lower portion of the first to sixth LED groups 110, 120, 130, 140, 150 and 160, have a desired shape, and communicate with each other in a longitudinal direction of the first to sixth LED groups 110, 120, 130, 140, 150 and 160.

The reflection plates 200 have curved side surfaces which reflect the light discharged from the first to sixth LED groups 110, 120, 130, 140, 150 and 160 respectively, so as to provide the light of a light distribution pattern with a narrow width. The light distribution pattern enables the LED lighting device to appropriately illuminate the playing field far away from a position at which the LED lighting device of the present invention is constructed.

The reflection plates 200 may be directly fixed to the substrate 100.

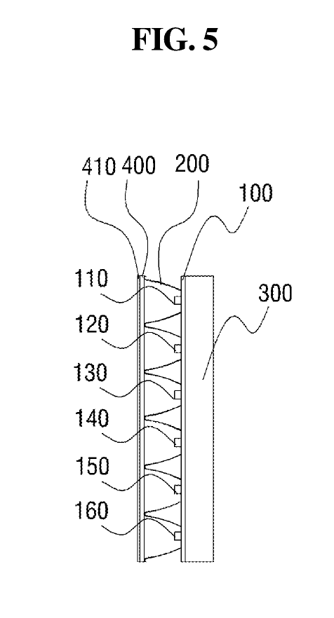

FIG. 4 is a graph illustrating a result of a simulation which shows a vertical light pattern of the first LED group 110 of the present invention.

The heat radiation unit 300 is provided on the rear surface of the substrate 100 and includes a plurality of heat radiation fins 310, in which the heat radiation fins 310 are arranged to be parallel with one another in a vertical direction so that airflow forming spaces 320 are defined between the heat radiation fins 310. These allow the airflow to be smoothly convected, thereby improving heat radiation efficiency.

As described above, the present invention forms the first to sixth LED groups 110, 120, 130, 140, 150 and 160 in each of which the LEDS are densely arranged in the row direction, and applies the reflection plate to the first to sixth LED groups 110, 120, 130, 140, 150 and 160 by a unit of each LED group, thereby reducing an area of the lighting device as compared with a conventional technology in which the reflection plate is provided to each of all LEDs.

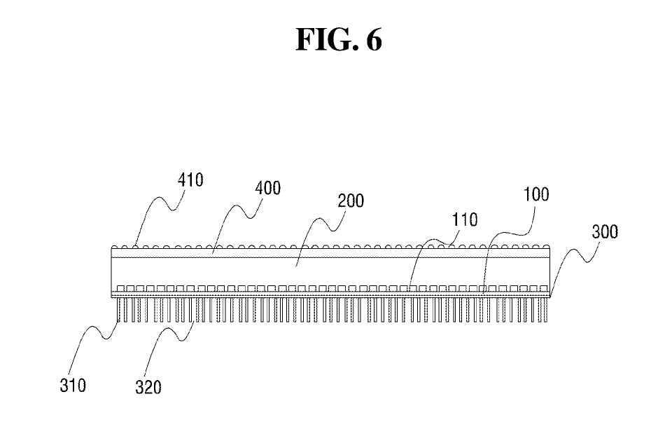

FIGS. 5 and 6 are sectional views illustrating a high power LED lighting device according to another embodiment of the present invention.

FIG. 5 is a sectional view illustrating the LED lighting device in which a lens 400 is applied to the structure of FIG. 2, and FIG. 6 is a sectional view illustrating the LED lighting device in which the lens 400 is applied to the structure of FIG. 3.

The lens 400 is fixed to an upper portion of the reflection plate 200 and has a long length in the row direction. The lens 400 has a protruding optical pattern 410 extending in the column direction perpendicular to the reflection plate 300. The protruding optical pattern 410 collects lights emitted from the first to sixth LED groups 110, 120, 130, 140, 150 and 160, so as to form more suitable light distribution as the illuminating for the playing field.

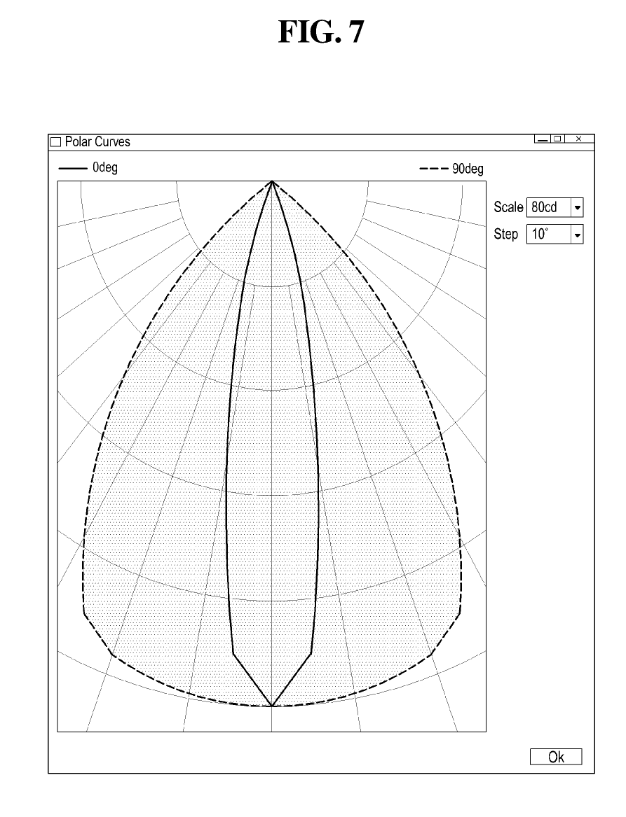

FIG. 7 is a graph illustrating a result of a simulation which shows a horizontal light distribution pattern of the first LED group 110. Referring to FIG. 7, the LED lighting device with the lens 400 can make a distance between both sides narrow to form a concentrated light distribution pattern.

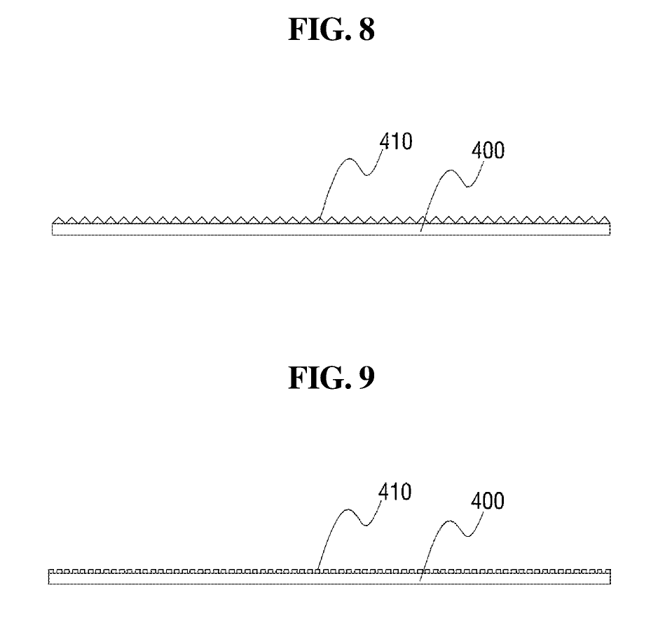

The protruding optical pattern 410 may have a semi-circular shape in a section, and as shown in FIGS. 8 and 9, another example of the protruding optical pattern 410 may have a triangle shape or a square shape in a section. The protruding optical pattern 410 with various shapes may be applied according to a necessity, and the present invention is not limited by the shape of the protruding optical pattern 410.

Although the present invention has been described with reference to the embodiments, it is obvious to those skilled in the art to which the present invention belongs that the present invention is not limited to the embodiments, and may be variously changed and modified without departing from the scope of the present invention.

What is claimed is:

1. A high power LED lighting device, comprising:
a substrate on which a plurality of LED groups, each of which including a plurality of LEDs in a row direction, is arranged in a column direction and the LED groups have a wider distance therebetween than that between the LEDs belonging to each LED group;
a plurality of reflection units which are located between the LED groups on a front surface of the substrate and reflect lights emitted from the LED groups to form light distribution; and
a heat radiation unit attached to a rear surface of the substrate to radiate heat.

2. The high power LED lighting device as claimed in claim 1, further comprising:
a lens mounted on the reflection unit so that a bottom surface of the lens is folded, and making the light distribution of the LED groups narrower.

3. The high power LED lighting device as claimed in claim 2, wherein the lens includes a protruding optical pattern which protrudes long in a row direction perpendicular to the reflection unit.
